(19) United States
(12) Patent Application Publication
(10) Pub. No.: US 2025/0006154 A1
(43) Pub. Date: Jan. 2, 2025

(54) Tone Changer Device for a Stringed Musical Instrument

(71) Applicant: Thamir Naidoo, Saskatoon (CA)

(72) Inventor: Thamir Naidoo, Saskatoon (CA)

(21) Appl. No.: 18/697,856

(22) PCT Filed: Sep. 29, 2022
(86) PCT No.: PCT/CA2022/051448

§ 371 Date: Apr. 2, 2024

Related U.S. Application Data
(60) Provisional application No. 63/275,102, filed on Nov. 3, 2021.

(51) Int. Cl. G10D 3/153; G10D 1/08; G10D 3/04; G10D 3/06; G10D 3/12

(52) U.S. Cl. CPC G10D 3/153; G10D 1/085; G10D 3/04; G10D 3/06; G10D 3/12

(57) ABSTRACT

A device for changing tone of a stringed musical instrument comprises a first portion arranged for mounted to a body of the instrument and a second portion movably connected to the first portion and operatively connected to strings of the instrument. The first and second portions are configured to collectively form a chamber with an axis arranged substantially parallel to the instrument strings. The chamber is adjustable in its axial dimension to have a variable volume which is varied by relative movement between the first and second portions. The chamber is substantially fluidically sealed and contains a substantially incompressible fluid for opposing the relative movement between the two portions. An actuator is operatively connected to the movable portion to actuate the relative movement to adjust tension in the strings to change the tone of the instrument when strummed.

### FIELD OF THE INVENTION

The present invention relates generally to a device for changing tone of a stringed musical instrument, and more particularly to such a device which forms a variable-volume chamber, which contains a fluid and is collectively formed by a first portion connected in fixed relation to a body of the instrument and a second portion connected in fixed relation to strings of the instrument.

### BACKGROUND

A commonplace, well-known device for changing tone of a stringed musical instrument, typically a guitar, is a cantilever floating tremolo sprung system. This system utilizes Hooke's Law (F/x=K) as a physical mechanism for movement of a floating bridge of the system, which is connected to strings of the instrument. The bridge is displaceable from a neutral, equilibrium or in-tune position, in which the tone corresponds to a tuning of the tensioned strings, to a low pitch position, in which the strings are relaxed to lower musical tone or pitch thereof, and a high pitch position, in which the strings are stretched to raise or increase the musical tone thereof. In this system, the floating bridge is operatively connected to a spring which defines the equilibrium or in-tune position.

Springs have what is termed in industry, particularly manufacturing, as memory. Spring steel, when bent into shape, keeps its shape, which is referred to as memory.

Thus, in a cantilever floating tremolo, the movement of the bridge to tighten or loosen the strings acts to gradually degrade the spring's rate, over time, and of course causes the guitar to play out of tune.

Another shortcoming of a floating tremolo system is that substantial material, usually wood, is removed from a body of the instrument to facilitate mounting of constituent components of the tremolo system. The lesser amount of material acts to change the tone of the instrument.

Further shortcomings of sprung tremolo systems may include:
cost to the user can be expensive if user plays many times per year;
can be related to use of strings per year as strings stretch and go out of tune;
cantilever design;
considerable removal of wood body needed for mounting;
for electric guitars only;
springs make the assembly heavy;
all strings loosen or tighten at the same time;
cost of manufacture is more expensive using springs.

### SUMMARY OF THE INVENTION

According to an aspect of the invention there is provided a device for changing tone of a stringed musical instrument,
wherein the stringed musical instrument has:
   an instrument body adapted to transmit sound,
   a neck attached to the instrument body and extending therefrom to a distal end of the neck disposed in spaced relation to the instrument body,
   a plurality of strings arranged side-by-side relative to a transverse direction of the instrument and extending substantially longitudinally of the instrument from first ends of the strings supported at or adjacent the distal end of the neck to second ends of the strings registered with the instrument body, and
   a bridge attached in fixed relation to the instrument body closer to the second ends of the strings than the first ends thereof and configured to receive the strings;
the device comprising:
a body mount configured for attaching to the instrument body;
a string mount supported by the body mount and configured to attach to the second ends of the strings, wherein the string mount is configured to move relative to the body mount in a longitudinal direction of the instrument;
wherein the body mount and string mount are configured to collectively form at least one chamber with a chamber axis arranged substantially parallel to the strings of the instrument, wherein said at least one chamber is adjustable in its axial dimension to have a variable volume which is varied by relative movement between the string mount and the body mount;
wherein said at least one chamber is substantially fluidically sealed and contains a substantially incompressible fluid for opposing the relative movement between the string and body mounts; and
an actuator operatively connected to the string mount to actuate the relative movement between the string and body mounts to adjust tension in the strings to change the tone of the instrument when strummed.

This provides a spring-less arrangement for a tone changer device for a stringed musical instrument, instead replaced by a mechanism which should not degrade in performance with time, thereby retaining an equilibrium tension of the strings to which they are initially tuned.

Typically, the substantially incompressible fluid is gaseous.

For example, the gaseous, substantially incompressible fluid is air.

In one arrangement, the string mount is arranged substantially on an opposite side of the body mount to the neck of the instrument.

In one such arrangement, the bridge is supported on the body mount.

In the illustrated arrangements, the at least one chamber is respectively formed by a cylindrical passageway and a piston insertably received therein.

In the illustrated arrangements, the body mount forms the passageway and the string mount forms the piston.

In the illustrated arrangements, an end of said at least one chamber which is arranged in substantially fixed location relative to the instrument body is formed by a flexible resilient diaphragm.

In the illustrated arrangements, the at least one chamber comprises a plurality of chambers which are transversely side-by-side.

Preferably, the chambers are fluidically intercommunicated.

In one arrangement, the string mount comprises a plurality of string mounts forming the plurality of the chambers, which are grouped in multiple subsets of the chambers, and the string mounts are independently movable to each other and configured to respectively attach to subsets of the strings such that tones of the subsets of the strings are independently adjustable.

Preferably, in such an arrangement, the actuator comprises a plurality of actuators respectively operatively connected to the plurality of string mounts for independent actuation thereof.

In the illustrated arrangements, the passageways are formed by cavities in a common body of material forming the body mount.

Preferably, the body mount and the string mount are arranged externally of the instrument body.

In the illustrated arrangements, the actuator comprises a lever pivotally supported on the body mount and having a track matably receiving a shaft projecting from and supported on the string mount.

In the illustrated arrangements, the string mount is slidably coupled to the body mount for slidable movement relative thereto.

In the illustrated arrangements, the body mount and string mount are respectively made of metallic materials, and at least one of the passageway and the piston is coated with a solid material having a lower coefficient of friction than a corresponding one of the metallic materials forming said at least one of the passageway and the piston.

In the illustrated arrangements, the solid material comprises polytetrafluoroethylene.

In one arrangement, the device further includes a diaphragm limiter disposed externally of said at least one chamber and supported for selective engagement with an external face of the diaphragm, wherein the diaphragm limiter is configured to resist outward deformation of the diaphragm beyond a prescribed threshold.

In one arrangement, the actuator comprises a remote actuator arranged for attaching to the instrument body in spaced relation to the string mount and comprising a fluid-receiving chamber distinct from the at least one chamber collectively formed by the body mount and the string mount. In such an arrangement, the chamber of the remote actuator is configured to be adjustable to have a variable volume, and the chamber of the remote actuator is in operative fluidic communication with the at least one chamber collectively formed by the body mount and the string mount so as to form therewith a common chamber which is substantially fluidically sealed.

In the illustrated arrangement, the chamber of the remote actuator is formed by at least one cylindrical passageway and at least one piston respectively insertably received therein.

In the illustrated arrangement, each of the at least one passageway of the remote actuator has a closed end in opposite relation to the least one piston and an opening in a peripheral wall of the passageway for fluidic communication with said at least one chamber.

In one arrangement, when the at least one chamber collectively formed by the body mount and the string mount comprises a plurality of transversely side-by-side chambers, the body mount forms a transversely-extending duct in fluidic communication with the plural chambers and with the chamber of the remote actuator.

In the illustrated arrangement, the plural chambers are disposed in a common plane and the duct is disposed in a distinct plane therefrom.

In one arrangement, when the plural chambers are respectively formed by cylindrical passageways and pistons respectively insertably received therein, and when ends of the plural chambers which are arranged in substantially fixed location relative to the instrument body are formed by a flexible resilient diaphragm, the passageways of the plural chambers have closed ends opposite to the pistons and transmission openings in peripheral walls of the passageways, the transmission openings are in fluidic communication with the duct, and the diaphragm is operatively supported by the duct in opposite relation to the transmission openings.

In the illustrated arrangement, the transverse duct includes a plurality of bores in a peripheral wall thereof and opposite the transmission openings in the passageways of the plural chambers, and the diaphragm is operatively supported to cover the bores.

In one arrangement, when the chamber of the remote actuator is formed by a body mounting portion configured for attaching to the instrument body and a movable portion supported by the body mounting portion and configured to move relative thereto along an axis, the remote actuator further comprises a lever pivotally supported on the body mounting portion and having a track matably receiving a shaft projecting from and supported on the movable portion.

In one such arrangement, the lever of the remote actuator is pivotally supported for movement about a pivot axis arranged to be parallel to a face of the instrument body.

In the illustrated arrangement, the chamber of the remote actuator is in operative fluidic communication with the at least one chamber collectively formed by the body mount and the string mount by a flexible hose.

### BRIEF DESCRIPTION OF THE DRAWINGS

The invention will now be described in conjunction with the accompanying drawings in which:

FIGS. 1 and 2 are perspective and top plan views, respectively, of a first arrangement of device for changing tone of a stringed musical instrument mounted on a guitar;

FIG. 3 is a perspective view of the tone changer device of FIG. 1;

FIGS. 4A and 4B are cross-sectional views shown in perspective and plan, respectively, taken along line 4-4 of FIG. 5, which shows the tone changer device of FIG. 1;

FIG. 5 is a top plan view of the tone changer device of FIG. 1;

FIG. 6 is an exploded view of the tone changer device of FIG. 1;

FIG. 7 is a side view of the tone changer device of FIG. 1 showing the side on which an actuator of the device is supported;

FIGS. 8 and 9 are front and rear views, respectively, of the tone changer device of FIG. 1;

FIGS. 10 and 11 are perspective and top plan views of a second arrangement of device for changing tone of a stringed musical instrument mounted on a guitar;

FIGS. 12 and 13 are perspective and top plan views, respectively, of the tone changer device of FIG. 10;

FIG. 14 schematically shows a plan view of a third arrangement of device for changing tone of a stringed musical instrument with a remote actuator;

FIG. 15 is a cross-sectional view along line 15-15-in FIG. 14;

FIG. 16 is a cross-sectional view along line 16-16 in FIG. 14;

FIG. 17 is a cross-sectional view along line 17-17 in FIG. 14; and

FIG. 18 schematically shows a side view of the third arrangement of FIG. 14.

In the drawings like characters of reference indicate corresponding parts in the different figures.

### DETAILED DESCRIPTION

The accompanying figures show a device 20 for changing tone of a stringed musical instrument 1, such as a guitar. This type of device is commonly known in the musical industry as a tremolo, although technically it performs a vibrato effect, and therefore may be referred to as a vibrato device.

Generally speaking, the stringed musical instrument 1 comprises a body 2 adapted to transmit sound; a neck 3 attached to the instrument body 2 and extending therefrom to a distal end 5 of the neck disposed in spaced relation to the body; a plurality of strings 7 arranged side-by-side relative to a transverse direction of the instrument and extending substantially longitudinally of the instrument from first ends 9 of the strings supported at or adjacent the distal end 5 of the neck to second ends 10 of the strings registered with the instrument body 2; and a bridge 12 attached in fixed relation to the instrument body closer to the second ends 10 of the strings than the first ends 9 thereof and configured to receive the strings. The second ends 10 of the strings are operatively connected to the instrument body 2, for example by the bridge 12, so that vibration thereof, upon strumming, is transferred to the body 2 for subsequently transmitting sound.

The strings 7 extend longitudinally linearly and in a common plane, so as to be coplanar, between a spaced pair of mounting or attachment locations to the instrument, for example at the distal neck end 5 and the bridge 12. Between these mounting locations are presented majority lengths of the strings which can be strummed to vibrate. On the other side of these mounting locations, the strings 7 may follow different respective paths for operative mounting to the instrument. Furthermore, the strings 7, typically, are also parallel to one another and are arranged in spaced relation to each another so that they can be individually strummed.

When the stringed musical instrument is a guitar, which is one of the most common types of stringed instruments with which tremolos are used, the neck 3 extends linearly, that is along a linear path, to the distal end 5, where a headstock 14 may be provided in fixed attachment thereto in order to operatively support the first ends 9 of the string so that they are supported in proximity to the distal neck end 5. The neck 3 extends parallel to the longitudinal direction of the stringed musical instrument, and may be considered to define a longitudinal axis 16 of the stringed musical instrument, which is located transversely centrally of the body.

The headstock 14 typically locates a plurality of rotatable spools or shafts 18 (schematically shown) to which the first string ends 9 are respectively fixedly connected and which are configured to windingly receive the strings to set an equilibrium tension (tone) of the strings.

Furthermore, in the case of an electric guitar, the body 2 is adapted to transmit sound by carrying or housing components, such as electrical pick-ups, which operatively receive vibration of the strings for transmission of one or more electrical signals to a speaker.

Turning now to the tone changer device 20, this comprises a body mount 22 configured for attaching to the instrument body 2, and a string mount 24 supported by the body mount and configured to attach to the second ends 10 of the strings. The string mount 24 is configured to move relative to the body mount in the longitudinal direction of the instrument. Typically, the body mount 22 is attached in fixed relation to the instrument body 2 so as to be immovable relative thereto.

The body and string mounts 22, 24 are configured to collectively form at least one chamber 26 with a respective chamber axis 27 arranged substantially parallel to the strings of the instrument. Since the strings 9 extend in the longitudinal direction of the instrument, the chamber axis 27 is considered to be oriented substantially longitudinally of the instrument.

The at least one chamber 26 is adjustable in its axial dimension (along the axis 27) to have a variable volume which is varied by relative movement between the string mount 24 and the body mount 22.

Furthermore, the at least one chamber 26 is substantially fluidically sealed and contains a substantially incompressible fluid 29 for opposing the relative movement between the string and body mounts 24, 22. Since the chamber is substantially fluidically sealed, such that the mass or amount of fluid therein does not change, thus is formed a closed system.

Typically, the trapped fluid 29 is gaseous, and thus may be an ideal gas. Practically speaking, a suitable gaseous fluid that is substantially incompressible, for use in the variable volume chamber 26, is air, which is substantially incompressible at flow velocities of 100 m/s or less.

An amount of the fluid received in the at least one chamber 26 is sized to provide the equilibrium tension of the strings. In other words, the amount of fluid in the at least one chamber is based on the equilibrium tension. This amount of the fluid generally corresponds to atmospheric or ambient pressure at an intermediary one of the volumes within a range of potential volumes within which the at least one chamber 26 can be adjusted, such that the chamber can be varied in volume from the equilibrium condition.

In addition, the tone changer device 20 includes an actuator 31 operatively connected to the string mount 24 to actuate the relative movement between the string and body mounts 24, 22 to adjust tension in the strings 7 to change the tone of the instrument when strummed. The actuator 31 is configured to receive input, typically physical, from a user playing the instrument, namely a player or musician.

There is provided a prescribed equilibrium volume of the chamber, which corresponds to a prescribed axial position of the string mount relative to the body mount, at which the trapped fluid does not exert any force so as not to be conducive to any relative displacement of the two mounts 22, 24. This equilibrium corresponds to an equilibrium tension of the strings, to which they are tuned by tightening usually by a distinct mechanism from the tone changer device 20.

Therefore, when the actuator 31 is used to displace the string mount 24 in a direction which enlarges the respective chamber from the equilibrium volume, the trapped fluid 29 acts to apply a suction-type force on the string mount to urge it to return to the equilibrium position. Conversely, when the string mount 24 is displaced in a direction which shrinks or contracts the respective chamber 26 from the equilibrium volume, then the trapped fluid 29 acts to apply an expansion-type force on the string mount 24 to urge it to return to the equilibrium position.

In the illustrated arrangements, the at least one chamber 26 is respectively formed by a cylindrical passageway 33A and a piston 33B insertably received therein. The passageway 33A has fixed length and at least one open end 34 through which the piston 33B passes, and the piston has an end 36 defining a surface interior to the passageway 33A which defines a movable end wall of the chamber. In the illustrated arrangements, the body mount 22 forms the passageway 33A and the string mount forms the piston 33B, which dimensionally is usually the smaller structure in comparison to the passageway, hence the string mount may be lighter so as to be easier to move. To fluidically seal an interface between the piston 33B and the passageway 33A in the illustrated arrangement, the piston 33B carries a resilient annular gasket that is arranged to engage a peripheral wall of the passageway 33A.

Since the stringed musical instrument 1 has multiple strings 7 which are transversely spaced apart such that the string mount 24 is reasonably wide, the at least one chamber 26 comprises a plurality of chambers, such as those indicated at 26A through 26D, which are transversely side-by-side to afford suitable performance. However, the chambers 26A-26D are fluidically intercommunicated for pressure equalization across the multiple chambers. This is provided by a fluidic passageway 39 interconnecting each adjacent pair of chamber passageways. In the illustrated arrangements, these bridging pressure-equalization passageways are arranged along a common transverse axis, so as to be all in-line.

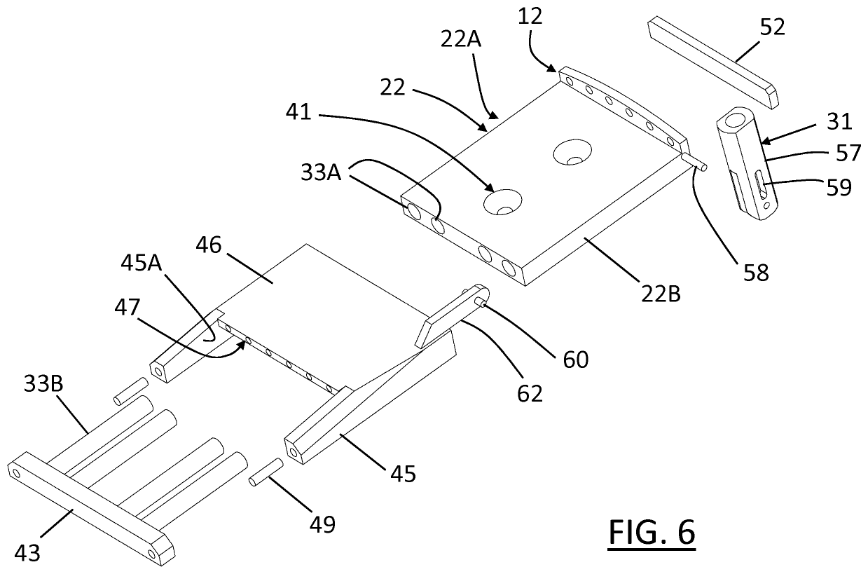

The passageways 33A are formed by cavities in a common body of material forming the body mount 22. In the illustrated arrangement, this is in the form of a substantially rectangular prism-like block, as more clearly shown in FIG. 6. For mounting to the instrument body 2, this block locates mechanical fasteners, for example screws, which are imbedded into the instrument body through apertures 41 in the block that are transversely offset from the passageways 33A so as not to interrupt same.

The string mount 24 comprises a plurality of parallel pistons, in this case indicated at 33B₁ through 33B₄, supported on a common transversely extending beam-type member 43, in the form of a bar. In the first of the illustrated arrangements, the pistons are cylindrical. The bar 43 is in turn connected by transversely spaced-apart, longitudinally-extending arms 45 to a thin plate-like body 46 disposed over the body mount 22 that locates passageways 47 receiving the instruments' strings 7. The second string ends 10 are affixed to the carrier plate 46 situated atop the body mount 22. In the illustrated arrangement, the arms 45 are distinct from the piston-carrier bar 43 but are integral with the string-carrier plate 46, so as to be connected to the bar 43 by interconnecting fasters 49.

An end of the respective chamber, each of 26A-26D, which is arranged in substantially fixed location relative to the instrument body 2 is formed by a flexible resilient diaphragm 52. The diaphragm 52 is resiliently deformable to soften (an initial portion of) the relative movement between the string and base mounts that causes compression or decompression of the trapped fluid, which is substantially incompressible. In the illustrated arrangement, the diaphragm 52 comprises a sheet of resilient pliable material, such as rubber and specifically a cold vulcanized neoprene rubber, covering an otherwise open end 54 of the respective passageway 33A.

To effect the relative movement between string mount and body mount, the string mount 24 is slidably coupled to the body mount for slidable movement relative thereto. More specifically, this is achieved by slidably matingly receiving the pistons 33B in the respective passageways 33A.

For durability, the body mount and string mount are respectively made of metallic materials, for example mild steel. Thus, at least one of the respective passageway 33A, formed in a metallic material so as to have a peripheral wall thereof, and the piston 33B matingly received therein are is coated with a solid material having a lower coefficient of friction than a corresponding one of the metallic materials forming the respective one of the passageway and the piston. The coating thus forms a thin layer of material on the metallic material forming the passageway and/or the piston. Since a resilient gasket is provided to fluidically seal the interface between the passageway and piston, which is carried on the piston meaning that the seal is in movable contact with the passageway's wall, then preferably the respective passageway is coated with the low-friction solid material, at minimum, and optionally the piston may be, too, for example to reduce friction between the passageway and piston in case of any inadvertent contact of solid surfaces. In the illustrated arrangements, the solid coating material comprises polytetrafluoroethylene, commonly known as Teflon™.

The sliding movement of the string mount 24 is actuated by the actuator 31 which comprises a lever 57 pivotally supported on the body mount 22 via a fixed support shaft 58 and having a track 59 matably receiving a shaft 60 projecting from and supported on the string mount 24 in fixed relation thereto. In the illustrated arrangement, the track 59 is in the form of a slot extending coaxially of the lever 57. The shaft 60 configured to traverse the slot is supported on a cantilevered arm 62 extending longitudinally from the carrier plate 46.

In the illustrated arrangements, the lever is in the form of a stub configured to receive an extension member arranged to extend from the stub to a position on an opposite side of the bridge, towards the neck 3.

It will be appreciated that the body and string mounts 22, 24 are configured such that there is a sliding interface external to the chambers 26, too. More particularly, the arms 45 joining the string-carrier plate 46 and the piston-support bar 43 are in parallel and spaced relation so as to slidably engage, with internal opposite surfaces 45A, opposite sides 22A, 22B of the body mount which form guide surfaces for the string mount 24.

To set or establish the equilibrium position of the tone changer device, there is provided a passageway 65 fluidically communicating the internal chamber(s) with an ambient environment of the tone changer device, which is closable by a removable plug 67 to fluidically seal the chamber. Initially, the plug is disposed in seated position fluidically sealing the chamber before the strings are tuned to the desired pitch, meaning that the mass or amount (moles) of fluid in the chamber remains constant. Since the tuning action causes the strings to be re-tensioned in a manner that may exert a net force on the string mount, the flexible diaphragm 52 may flex in a common direction as the force exerted by the tuned strings so as to establish an equilibrium volume of the chamber at the in-tune position.

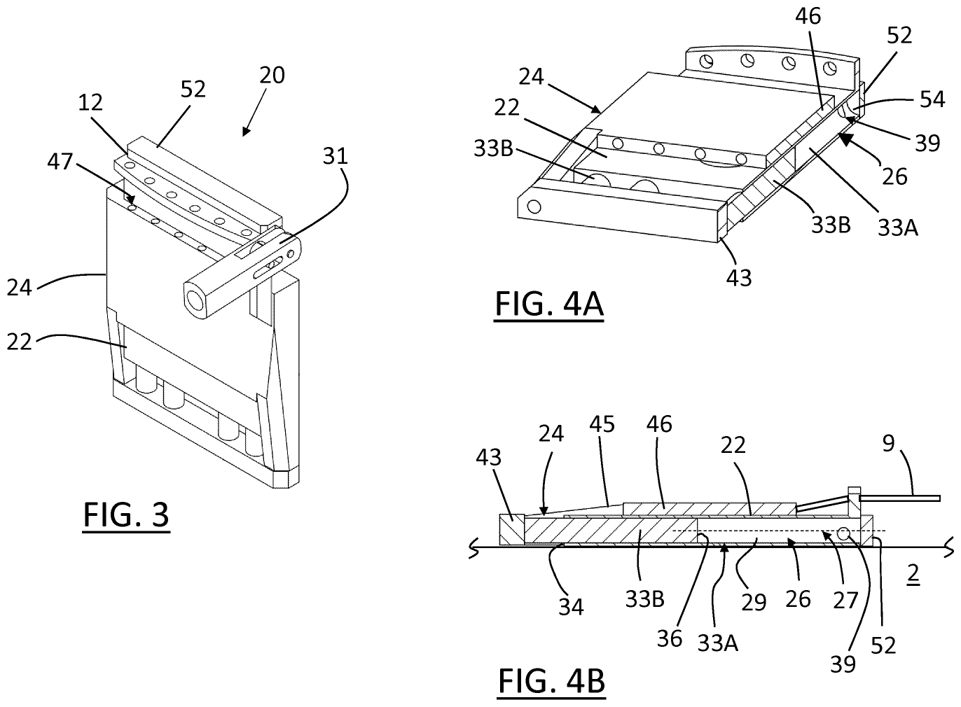

Furthermore, in the first illustrated arrangement, the bridge 12 is supported on the body mount 12, such that the body mount and bridge are unitary. In such an arrangement, the bridge 12 may have a relatively simply structure, as that shown more clearly in FIGS. 3 and 4A, being in the form of an upstanding flange with thru-holes 65 in which the strings are seated. Alternatively, the bridge may be of the type configured for tuning of (the tension in) the strings 7, particularly for fine-tuning thereof which is additional to tuning by wrapping on spools on the headstock.

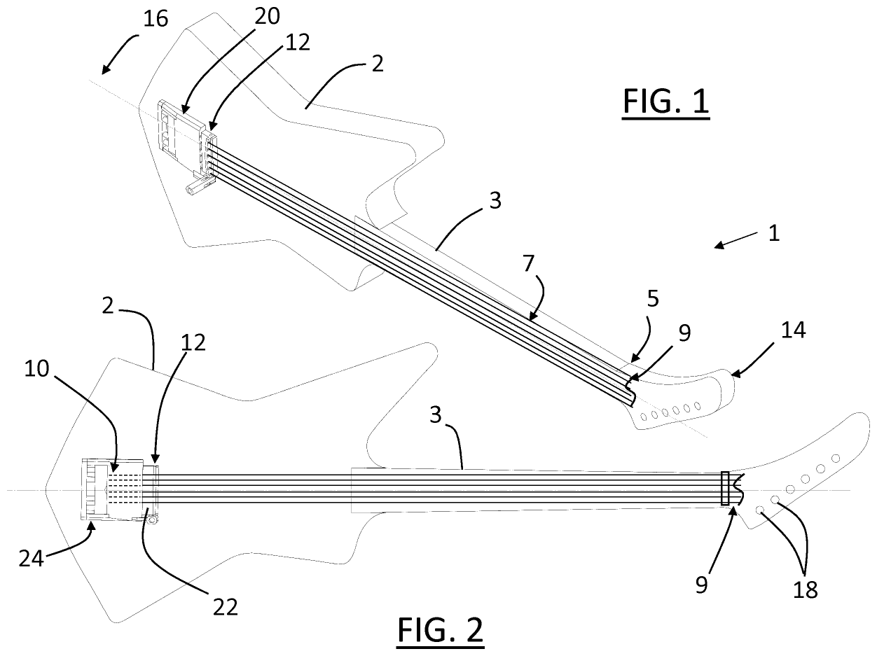

Referring back to FIGS. 1 and 2, it will be appreciated that in the first illustrated arrangement, the string mount 24 is arranged substantially on an opposite side of the body mount 22 to the neck 3 of the instrument, so as to be in distal relation to the neck. Although select portions of the string mount 24 overlap in longitudinal location with the body mount 22, namely the string-carrier plate 46, the chamber-forming portion of the string mount, that is the piston 33B, is positioned on the opposite side of the body mount to the instrument neck 3.

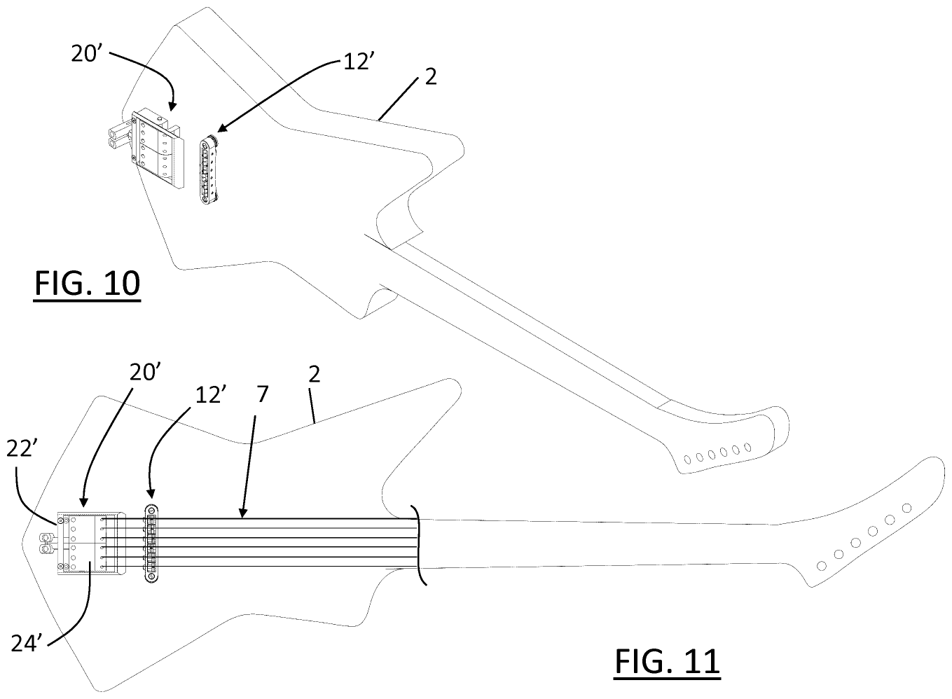

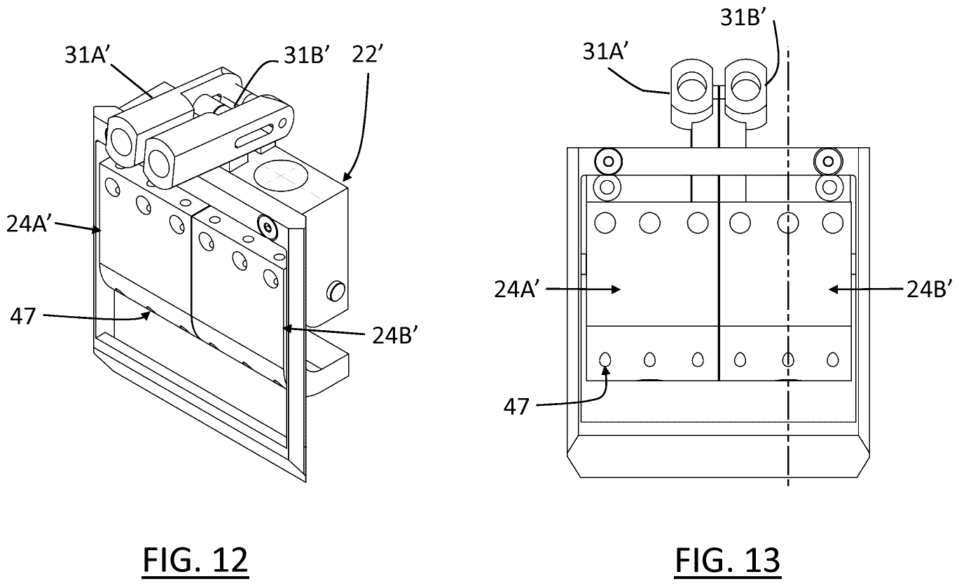

In other arrangements, such as that shown in FIGS. 10-13 and indicated at 20′, the string mount 24′ is substantially arranged in proximal relation to the neck 3. As such, the linear order of the string mount and body mount, relative to the bridge 12, which defines a common longitudinal location along the strings at which they are fixed in relation to the instrument body 2, does not matter, since the trapped fluid acts to maintain the variable volume chamber(s) at a constant volume unless a substantial external force, normally from a user/player, acts to overcome the action of the trapped fluid.

The second illustrated arrangement also shows the bridge 12′ as distinct from the tone changer device 20′. Furthermore, they are located in longitudinally spaced relation to one another, relative to the instrument (body).

In this second arrangement of tone changer device 20′, the string mount 24′ comprises a plurality of string mounts, for example 24A′ and 24B′, forming the plurality of the chambers (in this case there are a total of two, one for each mount 24A′ or 24B′), which are grouped in multiple subsets of the chambers. The string mounts 24A′, 24B′ are independently movable to each other and configured to respectively attach to subsets of the strings, for example three adjacent strings each, such that tones of the subsets of the strings are independently adjustable.

In the foregoing arrangement, the actuator 31′ comprises a plurality of actuators, such as 31A′ and 31B′, respectively operatively connected to the plurality of string mounts, in this case 24A′ and 24B′, for independent actuation thereof. Each of these actuators has the same structure as that previously described in respect of the first illustrated arrangement.

In the first and second illustrated arrangements, the body mount and the string mount are arranged externally of the instrument body. Thus, the tone changer device of the present invention may be suitable for use with an acoustic type guitar, and installation on other types of guitars, for example of the electric type, may be simpler.

In use, after strumming one or more of the strings of the instrument, and while they are vibrating:
To increase the tone or pitch of the vibrating strings, the actuator is operated to longitudinally displace the string mount in a direction that acts to stretch the vibrating strings; the resultant change in volume of the respective internal chamber, caused by the movement of the string mount relative to the body mount, causes the trapped fluid therein to exert a force on the movable string mount that urges the string mount to return to its previous, equilibrium position;
To lower the tone or pitch of the vibrating strings, the actuator is operated to longitudinally displace the string mount in a direction that acts to relax the vibrating strings; the resultant change in volume of the respective internal chamber causes the trapped fluid therein to exert a force on the movable string mount that urges the string mount to return to its previous, equilibrium position.

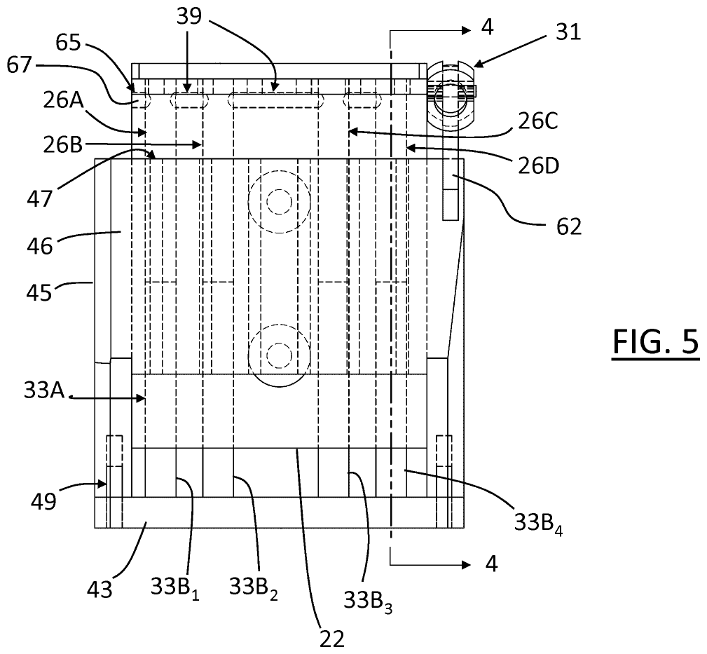

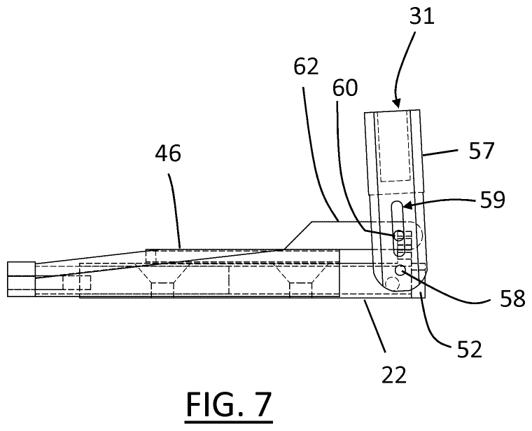

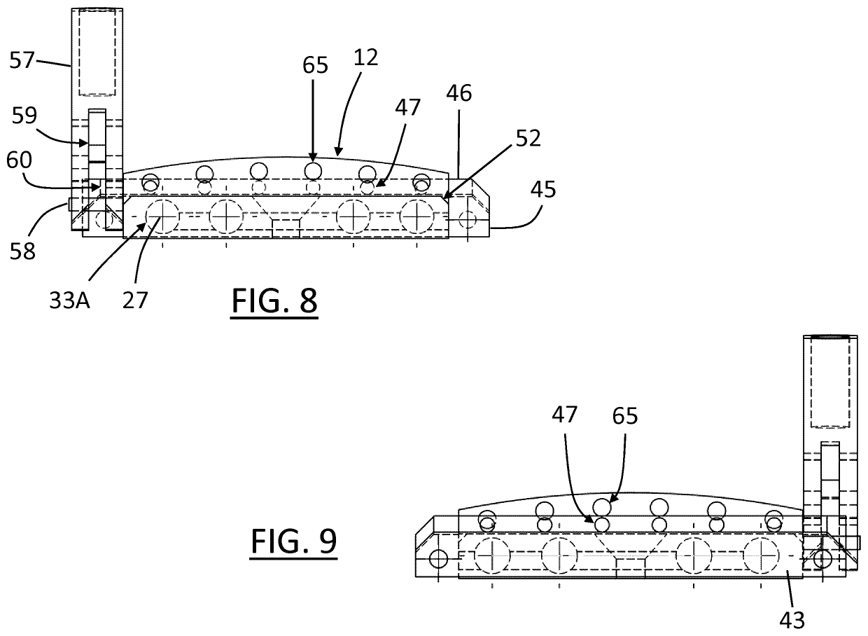

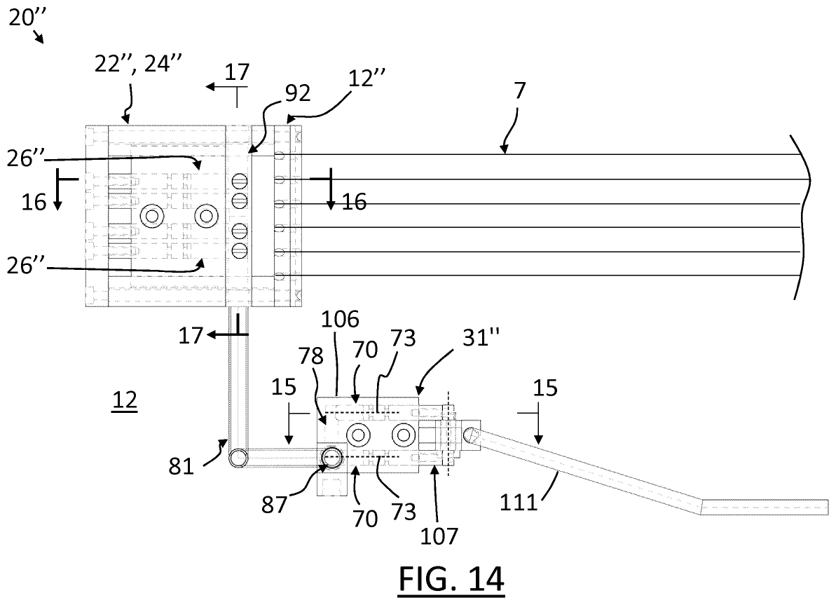

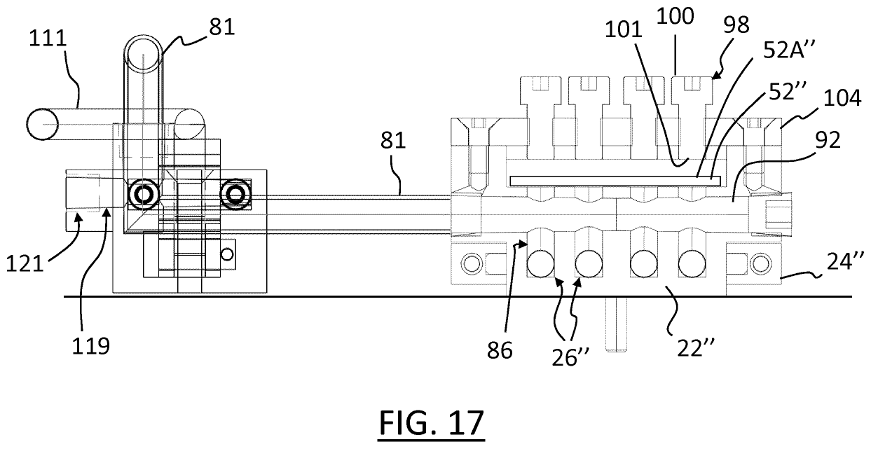

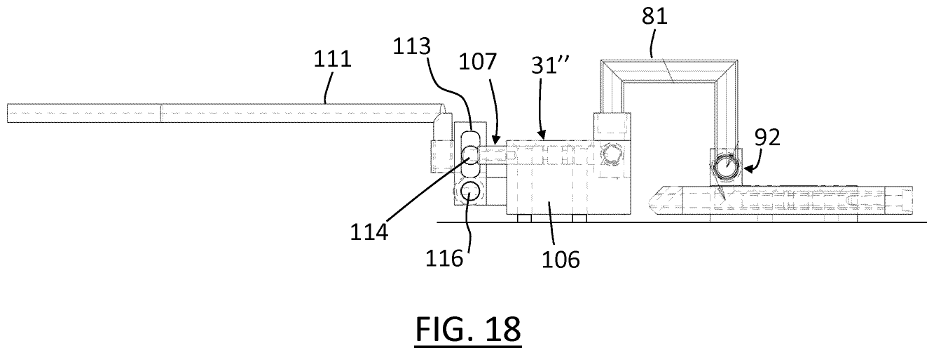

FIGS. 14-18 show a third arrangement of the device indicated at 20″ and with a remote actuator 31″ arranged in spaced relation to a string mount 24″. This arrangement of tone changer device has a similar design or structure of string mount and body mount as the first arrangement of FIGS. 1-9. As such, only substantial features unique to the third arrangement are described in further detail below.

In the tone changer device of FIGS. 14-18, the actuator comprises a remote actuator 31″ configured for attaching to the instrument body 12 in spaced relation to the string mount 24″. As such, the remote actuator 31″ is a physically distinct component from the string mount 24″, and furthermore, the actuator 31″ is mechanically detached therefrom. Thus, the remote actuator 31″ can be located in transversely spaced relation from the strings 7, relative to their longitudinal direction, as to be spaced from the strings 7 and particularly from the bridge 12″. Thus, the remote actuator 31″ can be located at a more ergonomic position for the user to play the instrument, for example longitudinally forwardly of the bridge 12, that is in a longitudinal direction towards the neck of the instrument, in generally longitudinal alignment with a strumming area of the strings 7, that is an area of the strings where they are plucked or engaged for vibration by the user.

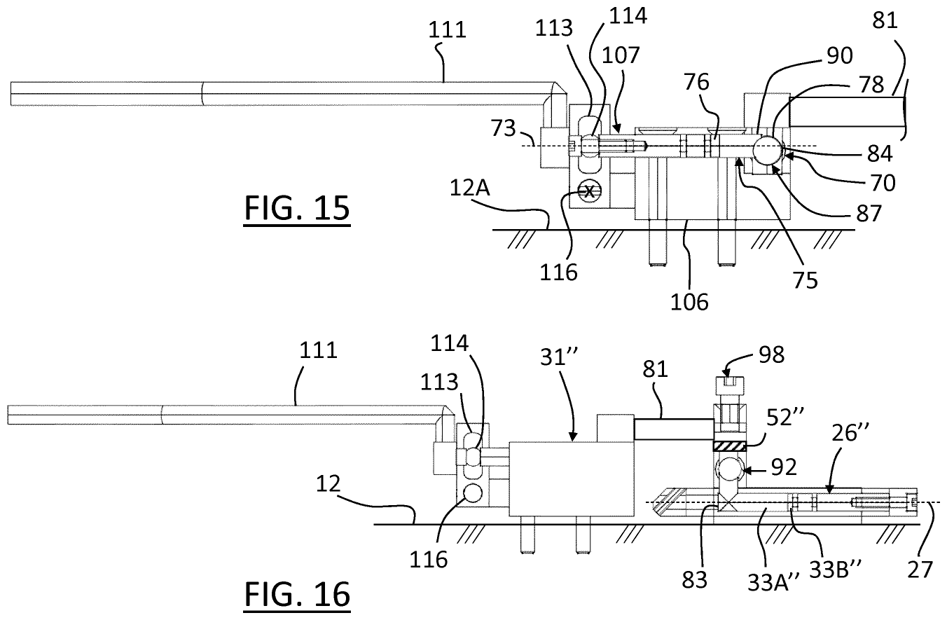

As more clearly shown in FIGS. 14 and 15, the remote actuator 31″ comprises a fluid-receiving chamber 70 (shown in phantom in FIG. 14) which is distinct from the one or more fluid-receiving chambers 26″ collectively formed by the body mount 22″ and the string mount 24″ and more clearly shown in FIG. 16. Thus, the remote actuator 31″ provides an auxiliary fluid-receiving chamber, which is substantially fluidically sealed, to the primary fluid-receiving chambers 26″, which are in transverse alignment with the strings 7, that is registered with the strings relative to a transverse direction thereof.

The auxiliary chamber 70 of the device 20″ which is in the remote actuator 31″ is configured to be adjustable to have a variable volume. More specifically, the auxiliary chamber 70 has a respective chamber axis 73 and is adjustable in its axial dimension to have the variable volume. In the illustrated arrangement, the chamber axis 73 is oriented substantially parallel to the primary chamber axes 27, as more clearly shown in FIG. 14.

Similarly to the primary chamber(s) 26″, the chamber 70 of the remote actuator is formed by at least one cylindrical passageway 75 and at least one piston 76 respectively insertably received therein. In the illustrated arrangement, the auxiliary chamber 70 is formed by plural cooperating passageways and pistons, which are disposed transversely side-by-side relative to the axial direction of the auxiliary chamber, and which again is similar to the configuration of the primary chambers. The plural passageways 75 of the remote actuator are fluidically intercommunicated by a passageway 78 extending transversely of the respective auxiliary chamber axes 73. Thus, although each pair of passageway and cooperating piston inserted therein forms a respective chamber, fluidic intercommunication acts to form a single common chamber for the remote actuator.

Preferably, the cross-sectional size of the auxiliary chamber is substantially uniform along the length of each of the constituent passageways, and is substantially the same as that of the primary chambers which are substantially the same and with uniform cross-sectional size along their lengths.

To operatively connect the remote actuator 31″ to the string mount 24″, the auxiliary chamber 70 is in operative fluidic communication with the one or more primary chambers 26″ so as to form therewith a common chamber which is substantially fluidically sealed, and which receives the substantially incompressible fluid 29. In the illustrated arrangement, this operative fluidic coupling is achieved by a flexible hose 81, which is flexible along its length. The flexible hose has a relatively fixed cross-sectional size, however, which is substantially the same as that of the primary and auxiliary chambers.

By varying the volume of the auxiliary chamber 70, which is fluidically communicated with the primary chambers 26″, the respective volumes of the primary chambers 26″ are varied in turn, causing the string mount 24″ to be displaced to change the tension in the strings 7 of the musical instrument.

In other words, when the volume of the auxiliary chamber is varied, the total volume of the common chamber and the fluidic line intercommunicating the constituent chambers thereof (that is, the primary and auxiliary chambers) remains substantially constant, but the volumes of the primary chambers change responsively to the change in the auxiliary chamber volume in a compensating or counteracting fashion to maintain the total volume substantially the same.

Even though the primary and auxiliary chambers 26″, 70 are fluidically intercommunicated and thus share a common quantity of substantially incompressible fluid, each of these constituent chambers acts as a distinct chamber because each of the passageways 33A″, 75 thereof has a closed end 83, 84 in opposite relation to a corresponding one of the pistons 33B″, 76 and an opening 86, 87 in a peripheral wall 89, 90 of the passageway 33A″, 75 for fluidic communication with the other one of the (two constituent) chambers. That is, for each passageway 33A″ or 75, the closed end thereof is in opposite relation to the mated piston 33B″ along the corresponding respective chamber axis 27 or 73. The closed ends 83, 84 of the passageways act as the fixed, immovable ends of the respective chambers, while the pistons act as the movable ends along the respective axis for varying the volume in the respective axial dimension.

As such, to facilitate responsive variation in primary chamber volume when the auxiliary chamber volume is varied, the body mount 22″ forms a transversely-extending duct 92 in fluidic communication with the plural primary chambers 26″ and the auxiliary chamber 70 of the remote actuator 31″. The duct 92 acts to convey or transmit the substantially incompressible fluid between the primary chambers 26″ and the flexible hose 81, and may be referred to as a transmission duct. The duct 92 has a cross-sectional size of a similar order as the primary and auxiliary chambers, which is substantially uniform along the full length of the duct. The transmission duct 92 is communicated with the openings 86 in the passageways 33A″ of the primary chambers, which may be referred to as transmission openings. In the illustrated arrangement, the plural primary chambers 26″ are disposed in a common plane and the transmission duct 92 is disposed in a distinct plane therefrom, which is distal to the instrument body 12 compared to the plane in which the primary chambers lie. Furthermore, it will be appreciated that in the illustrated arrangement, since the duct 92 and primary passageways 33A″ are integrally formed in a common body of material forming the body mount 22″, the transmission openings 86 form short passageways to fluidically interconnect the duct 92 and primary passageways 33A″ which are spaced apart by a thickness of the material of the body mount.

The arrangement of tone changer device with remote actuator still has a flexible resilient diaphragm 52″, but only a single one for the common chamber. The single diaphragm 52″ is operatively supported by the transmission duct 92 in opposite relation to the transmission openings 86. In the illustrated arrangement, the diaphragm 52″ is operatively associated with the common chamber by way of a plurality of bores 96 in a peripheral wall 92A of the transmission duct and disposed opposite the transmission openings 86 of the plural primary chambers. The diaphragm 52″ is operatively supported to cover the bores.

To ensure the diaphragm 52″ acts to transmit pressure applied thereto to upstream or downstream portions of the common chamber, depending on a direction or type of volume-variation of the auxiliary chamber, that is expansion or contraction thereof, the device 20″ further includes a diaphragm limiter 98 disposed externally of the primary chambers 26″ and supported for selective engagement with an external face 52A″ of the diaphragm 52″, that is a face of the diaphragm outside the common chamber. The diaphragm limiter 98 is configured to resist outward deformation of the diaphragm 52″ beyond a prescribed threshold. The prescribed threshold is determined, in the illustrated arrangement by manual tuning, in such a manner that changes in pressure or movement of fluid is transmitted to the movable ends of the common chamber, that is the pistons of the primary and auxiliary chambers. In the illustrated arrangement, the diaphragm limiter 98 comprises one or more elements 100 detached from the diaphragm and defining stop surfaces 101 in proximal relation to the diaphragm so as to be presented for engagement with the external face 52A″ thereof. In the illustrated arrangement, there are plural limiting elements arranged at spaced positions of the diaphragm. Typically, the end surfaces 101 of the limiting or stop elements 100 are in spaced relation to the external diaphragm face 52A″ in an equilibrium position of the diaphragm. Preferably, the elements 100 are adjustable in location relative to the diaphragm so as to be configured to change the prescribed threshold deformation. In the illustrated arrangement, this is achieved by threadably carrying the individual stop elements 100 on a cross-member 104 supported by the body mount 22″ and in spaced relation to the diaphragm 52″.

The remote actuator 31″ is formed by a body mounting portion 106 configured for attaching to the instrument body 12 and a movable portion 107 supported by the body mounting portion and configured to move relative thereto along an axis, which is the same axis 73 as that of the auxiliary chamber 70 or parallel thereto when there are multiple chambers forming the auxiliary chamber, as in the illustrated arrangement. In the illustrated arrangement, the body mounting portion 106 is in the form of a block or body of material with cavities defining the passageways 75 of the auxiliary chamber, and the movable portion 107 is formed by the pistons 76. Typically, the body mounting portion 106 is stationary and thus affixed to the instrument body 12, for example by mechanical fasteners.

It will be appreciated that the movable portion 107 and the string mount 24″ are disposed in opposite relation to one another relative to the direction of flow of the fluid within the common chamber.

Referring to FIG. 15, to operate the remote actuator, there is provided a lever 111 thereof pivotally supported on the body mounting portion 106 and having a track 113 matably receiving a shaft 114 projecting from and supported on the movable portion 107. In the illustrated arrangement, the lever 111 of the remote actuator is pivotally supported for movement about a pivot axis 116 arranged to be transverse to the auxiliary chamber axis 73 and parallel to a plane of a proximal face of the instrument body 12A. Also, the pivot axis 116 defined by a pin is disposed in a distinct plane from the auxiliary chamber axis/axes 73, and in this case is located closer to the instrument body 12 than the plane containing the axes 73. Thus, the lever is displaced in pivotal movement to elongate or contract the auxiliary chamber in its axial direction along axis 73.

For tuning, the device 20″ includes a fluidic connection point 119, that is a passageway, at the remote actuator 31″ in fluidic communication with the auxiliary chamber 70. The fluidic connection point 119 is sealingly closed by plug 121. The passageway 119 and plug 121 are substituted for the passageway 65 and plug 67 of the first arrangement. Tuning of this arrangement is substantially the same as the process described earlier in specific reference to the first arrangement.

In use of the arrangement with the remote actuator, after strumming one or more of the strings of the instrument, and while they are vibrating:
To increase the tone or pitch of the vibrating strings, the remote actuator 31″ is operated to reduce the volume of the auxiliary chamber 70 relative to an equilibrium volume at which the device 20″ is tuned, thereby displacing the trapped fluid in the common chamber, collectively formed by (i) the auxiliary chamber, (ii) the interconnecting fluidic line, including the hose 81 and the transmission duct 92, and (iii) the one or more primary chambers, towards an opposite end of the common chamber formed by the primary chambers 26″, causing the same to be volumetrically enlarged;
To lower the tone or pitch of the vibrating strings, the remote actuator is operated to enlarge the volume of the auxiliary chamber relative to the equilibrium volume thereof, thereby sucking or drawing the trapped fluid in the common chamber towards the auxiliary chamber and causing the primary chambers 26″ at the opposite end of the common chamber to be volumetrically reduced.

In either case, that is whether increasing or lowering the tone or pitch of the vibrating strings, local pressure differentials in the primary and auxiliary chambers act to return the same to their respective interrelated equilibrium positions, such that the device with remote actuator as a whole system returns to its equilibrium in-tune position.

This provides a spring-less arrangement for a tone changer device for a stringed musical instrument, having a mechanism of operation which should not degrade in performance with time, thereby retaining an equilibrium tension of the strings to which they are initially tuned.

In other words, as described hereinbefore, the present invention relates to a device for changing tone of a stringed musical instrument which comprises a first portion arranged for mounted to a body of the instrument and a second portion movably connected to the first portion and operatively connected to strings of the instrument. The first and second portions are configured to collectively form a chamber with an axis arranged substantially parallel to the instrument strings. The chamber is adjustable in its axial dimension to have a variable volume which is varied by relative movement between the first and second portions. The chamber is substantially fluidically sealed and contains a substantially incompressible fluid for opposing the relative movement between the two portions. An actuator is operatively connected to the movable portion to actuate the relative movement to adjust tension in the strings to change the tone of the instrument when strummed.

Boyle's Law states that “the absolute pressure exerted by a given mass of an ideal gas is inversely proportional to the volume it occupies if the temperature and amount of gas remain unchanged within a closed system.”

In the form of equations: P1V1=P2V2, and PV=k (Volumetric Force) where P1, P2 and P denote pressure; V1, V2 and V denote volume, and k is a constant.

A compressible rubber membrane 52 and a plug 67 are used to seal the system or chamber that is under the string terminal, referred to hereinbefore as the string mount, and a piston 33B is moved in either direction and is attached to a handle mount, referred to hereinbefore as a lever, to change the pitch of the strings. The piston 33B compresses and decompresses which allows the rubber membrane 52 to shift in and out of the piston bore creating the pressured energy needed to return the tremolo handle (arm) to a neutral position with the guitar strings under tension.

This system can be made thin enough to mount on the top of a guitar body without removing material from the body of a guitar.

The rubber membrane allows the pressure not to increase greatly to avoid large amounts of energy used to move the tremolo handle (arm). Rubber membrane 52 acts as a moving part when the guitar is tuned to set the neutral position or in tune characteristic of the guitar. The air passage bore hole is there to equalize the pressure between all four pistons.

Advantages of the novel tone changer device include:
no springs used to power the mechanism
uses free energy (of the trapped substantially incompressible fluid)
strings involved can be split to utilize an advanced playing style, loosening only three strings at a time
linear design, strings loosen quickly
suited for use on guitars and bass guitars
bolts on top of wood body, no removal of wood required
possible to manufacture for acoustic guitars
air is light and makes the assembly weigh less, less parts to manufacture and the cost is less.

The scope of the claims should not be limited by the preferred embodiments set forth in the examples but should be given the broadest interpretation consistent with the specification as a whole.

1. A device for changing tone of a stringed musical instrument,
wherein the stringed musical instrument has:
an instrument body adapted to transmit sound,
a neck attached to the instrument body and extending therefrom to a distal end of the neck disposed in spaced relation to the instrument body,
a plurality of strings arranged side-by-side relative to a transverse direction of the instrument and extending substantially longitudinally of the instrument from first ends of the strings supported at or adjacent the distal end of the neck to second ends of the strings registered with the instrument body, and
a bridge attached in fixed relation to the instrument body closer to the second ends of the strings than the first ends thereof and configured to receive the strings;
the device comprising:
a body mount configured for attaching to the instrument body;
a string mount supported by the body mount and configured to attach to the second ends of the strings, wherein the string mount is configured to move relative to the body mount in a longitudinal direction of the instrument;
wherein the body mount and string mount are configured to collectively form at least one chamber with a chamber axis arranged substantially parallel to the strings of the instrument, wherein said at least one chamber is adjustable in its axial dimension to have a variable volume which is varied by relative movement between the string mount and the body mount;
wherein said at least one chamber is substantially fluidically sealed and contains a substantially incompressible fluid arranged to oppose the relative movement between the string and body mounts; and
an actuator operatively connected to the string mount to actuate the relative movement between the string and body mounts to adjust tension in the strings to change the tone of the instrument when strummed.

2. The device of claim 1 wherein the string mount is arranged on an opposite side of the body mount to the neck of the instrument.

3. The device of claim 2, in combination with the bridge, wherein the bridge is supported on the body mount.

4. The device of any one of claims 1 to 3 wherein said at least one chamber is respectively formed by a cylindrical passageway and a piston insertably received therein.

5. The device of claim 4 wherein the body mount forms the passageway and the string mount forms the piston.

6. The device of any one of claims 1 to 5 wherein an end of said at least one chamber which is arranged in substantially fixed location relative to the instrument body is formed by a flexible resilient diaphragm.

7. The device of claim 6 further including a diaphragm limiter disposed externally of said at least one chamber and supported for selective engagement with an external face of the diaphragm, wherein the diaphragm limiter is configured to resist outward deformation of the diaphragm beyond a prescribed threshold.

8. The device of any one of claims 1 to 7 wherein said at least one chamber comprises a plurality of chambers which are transversely side-by-side.

9. The device of claim 8 wherein the chambers are fluidically intercommunicated.

10. The device of claim 8 or 9 wherein the string mount comprises a plurality of string mounts forming the plurality of the chambers, which are grouped in multiple subsets of the chambers, wherein the string mounts are independently movable to each other and configured to respectively attach to subsets of the strings such that tones of the subsets of the strings are independently adjustable.

11. The device of claim 10 wherein the actuator comprises a plurality of actuators respectively operatively connected to the plurality of string mounts for independent actuation thereof.

12. The device of any one of claims 8 to 11 wherein the passageways are formed by cavities in a common body of material forming the body mount.

13. The device of any one of claims 1 to 12 wherein the body mount and the string mount are arranged externally of the instrument body.

14. The device of any one of claims 1 to 13 wherein the actuator comprises a lever pivotally supported on the body mount and having a track matably receiving a shaft projecting from and supported on the string mount.

15. The device of any one of claims 1 to 14 wherein the string mount is slidably coupled to the body mount for slidable movement relative thereto.

16. The device of claim 15 wherein the body mount and string mount are respectively made of metallic materials, and at least one of the passageway and the piston is coated with a solid material having a lower coefficient of friction than a corresponding one of the metallic materials forming said at least one of the passageway and the piston.

17. The device of claim 16 wherein the solid material comprises polytetrafluoroethylene.

18. The device of any one of claims 1 to 17 wherein the actuator comprises a remote actuator arranged for attaching to the instrument body in spaced relation to the string mount, wherein the remote actuator comprises a fluid-receiving chamber distinct from said at least one chamber collectively formed by the body mount and the string mount, wherein the chamber of the remote actuator is configured to be adjustable to have a variable volume, wherein the chamber of the remote actuator is in operative fluidic communication with said at least one chamber collectively formed by the body mount and the string mount so as to form therewith a common chamber which is substantially fluidically sealed.

19. The device of claim 18 wherein the chamber of the remote actuator is formed by at least one cylindrical passageway and at least one piston respectively insertably received therein.

20. The device of claim 19 wherein the at least one passageway respectively has a closed end in opposite relation to the least one piston and an opening in a peripheral wall of a respective one of the at least one passageway for fluidic communication with said at least one chamber.

21. The device of any one of claims 18 to 20 wherein, when said at least one chamber comprises a plurality of chambers which are transversely side-by-side, the body mount forms a transversely-extending duct in fluidic communication with the plural chambers and with the chamber of the remote actuator.

22. The device of claim 21 wherein the plural chambers are disposed in a common plane and the duct is disposed in a distinct plane therefrom.

23. The device of claim 22 wherein, when the plural chambers are respectively formed by cylindrical passageways and pistons respectively insertably received therein, and when ends of the plural chambers which are arranged in substantially fixed location relative to the instrument body are formed by a flexible resilient diaphragm, the passageways have closed ends opposite to the pistons and transmission openings in peripheral walls of the passageways, wherein the transmission openings are in fluidic communication with the duct, and the diaphragm is operatively supported by the duct in opposite relation to the transmission openings.

24. The device of claim 23 wherein the duct includes a plurality of bores in a peripheral wall thereof and opposite the transmission openings in the passageways of the plural chambers, and the diaphragm is operatively supported to cover the bores.

25. The device of any one of claims 18 to 24 wherein, when the chamber of the remote actuator is formed by a body mounting portion configured for attaching to the instrument body and a movable portion supported by the body mounting portion and configured to move relative thereto along an axis, the remote actuator further comprises a lever pivotally supported on the body mounting portion and having a track matably receiving a shaft projecting from and supported on the movable portion.

26. The device of claim 25 wherein the lever of the remote actuator is pivotally supported for movement about a pivot axis arranged to be parallel to a face of the instrument body.

27. The device of any one of claims 18 to 26 wherein the chamber of the remote actuator is in operative fluidic communication with said at least one chamber collectively formed by the body mount and the string mount by a flexible hose.
